(19) United States
(12) Patent Application Publication
(10) Pub. No.: US 2025/0225631 A1
(43) Pub. Date: Jul. 10, 2025

(54) IMAGE PICKUP APPARATUS, ITS CONTROL METHOD, AND STORAGE MEDIUM

(71) Applicant: CANON KABUSHIKI KAISHA, Tokyo (JP)

(72) Inventor: DAISUKE SAKAMOTO, Kanagawa (JP)

(21) Appl. No.: 19/065,047

(22) Filed: Feb. 27, 2025

Related U.S. Application Data
(63) Continuation of application No. PCT/JP2023/025231, filed on Jul. 7, 2023.

(30) Foreign Application Priority Data
Sep. 29, 2022 (JP) 2022-156821

(51) Int. Cl. G06T 5/80; G06T 3/12; G06T 3/40; G06T 5/50

(52) U.S. Cl. CPC G06T 5/80; G06T 3/12; G06T 3/40; G06T 5/50; G06T 2207/20212

(57) ABSTRACT

An image pickup apparatus includes an imaging unit configured to acquire a captured image, and a processor configured to perform predetermined transformation processing for correcting image distortion for at least one partial area of the captured image to generate a transformed image, perform focus peaking processing for at least one of the captured image and the transformed image to generate a focus-peaking image, generate a combined image of the at least one of the captured image and the transformed image, and the focus-peaking image, and control a display unit so as to display the combined image. In a case where the processor is set to perform the focus peaking processing for the transformed image to display the combined image, the processor causes the display unit to display the combined image of the transformed image and the focus-peaking image. The partial area includes a peripheral part of the captured image.

### CROSS-REFERENCE TO RELATED APPLICATIONS

This application is a Continuation of International Patent Application No. PCT/JP2023/025231, filed on Jul. 7, 2023, which claims the benefit of Japanese Patent Application No. 2022-156821, filed on Sep. 29, 2022, both of which are hereby incorporated by reference herein in their entirety.

### BACKGROUND

### Technical Field

The present disclosure relates to an image pickup apparatus, its control method, and a storage medium.

### Description of Related Art

Japanese Patent No. 6897268 discloses an image pickup apparatus that can capture an omnidirectional (360-degree) image at once as an image pickup apparatus for acquiring virtual reality (VR) content (captured image) such as photos and videos for VR. The VR content is visually recognized by a user, for example, using a non-transparent type head mount display (HMD).

An image pickup apparatus having a (focus) peaking function has recently been known. The peaking function is a function for highlighting the contours of an in-focus part by combining a peaking image obtained by extracting and amplifying high-frequency components from a luminance signal included in an input image signal with an original input image and displaying the combined image. Displaying the combined image in a live-view on an electric viewfinder (EVF) or a liquid crystal monitor (rear monitor) of the image pickup apparatus enables the user to visually recognize the in-focus part, and easily perform focusing. Japanese Patent Laid-Open No. 2021-64837 discloses an image pickup apparatus configured to switch between performing peaking processing for a captured image and performing peaking processing for a reduced image of the captured image according to a noise amount.

The image acquired by VR imaging is a fisheye image (circumferential fisheye image). In a case where the fisheye image for which peaking processing is performed is displayed in live-view on the EVF or rear monitor, the image display is different from that of the HMD that is used for actual viewing by the user, and the focus state may differ from that intended by the user. In particular, the object is significantly distorted in the peripheral part of the circumferential fisheye image, and is therefore likely to be extracted as a high-frequency component. Thus, with the image pickup apparatuses disclosed in Japanese Patent No. 6897268 and Japanese Patent Laid-Open No. 2021-64837, the user has difficulty in determining whether the peripheral part of the circumferential fisheye image is actually in focus.

### SUMMARY

An image pickup apparatus according to one aspect of the disclosure includes an imaging unit configured to acquire a captured image, and a processor configured to perform predetermined transformation processing for correcting image distortion for at least one partial area of the captured image to generate a transformed image, perform focus peaking processing for at least one of the captured image and the transformed image to generate a focus-peaking image, generate a combined image of the at least one of the captured image and the transformed image, and the focus-peaking image, and control a display unit so as to display the combined image. In a case where the processor is set to perform the focus peaking processing for the transformed image to display the combined image, the processor causes the display unit to display the combined image of the transformed image and the focus-peaking image. The partial area includes a peripheral part of the captured image. A control method of the above image pickup apparatus also constitutes another aspect of the disclosure. A storage medium storing a program that causes a computer to execute the above control method also constitutes another aspect of the disclosure.

Further features of various embodiments of the disclosure will become apparent from the following description of embodiments with reference to the attached drawings.

### BRIEF DESCRIPTION OF THE DRAWINGS

FIG. 1 is a block diagram of the image pickup apparatus according to a first embodiment.

FIGS. 2A, 2B, and 2C explain peaking processing in each embodiment.

FIGS. 3A, 3B, and 3C explain a captured image and a perspective projection image during VR imaging in each embodiment.

FIGS. 4A and 4B explain the correspondence between a captured image and a hemisphere in a three-dimensional virtual space in each embodiment.

FIG. 5 explains virtual camera in the three-dimensional virtual space and the position of an area for perspective projection transformation in the hemispherical image in each embodiment.

FIG. 6 is a flowchart illustrating display processing of the image pickup apparatus according to the first embodiment.

FIG. 7 illustrates display contents of the image pickup apparatus according to the first embodiment.

FIG. 8 explains captured images of VR180 in the first embodiment.

FIG. 9 illustrates the display content of VR180 in the image pickup apparatus according to the first embodiment.

FIG. 10 is a block diagram of an image pickup apparatus according to second and third embodiments.

FIG. 11 is a flowchart illustrating display processing of the image pickup apparatus according to the second embodiment.

FIG. 12 illustrates the display content of the image pickup apparatus according to the second embodiment.

FIG. 13 illustrates the display contents of VR180 of the image pickup apparatus according to the second embodiment.

FIG. 14 is a flowchart illustrating the display processing of the image pickup apparatus according to the third embodiment.

FIG. 15 illustrates the display content of the image pickup apparatus according to the third embodiment.

FIG. 16 illustrates the display content of VR180 of the image pickup apparatus according to the third embodiment.

### DETAILED DESCRIPTION

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure.

### First Embodiment

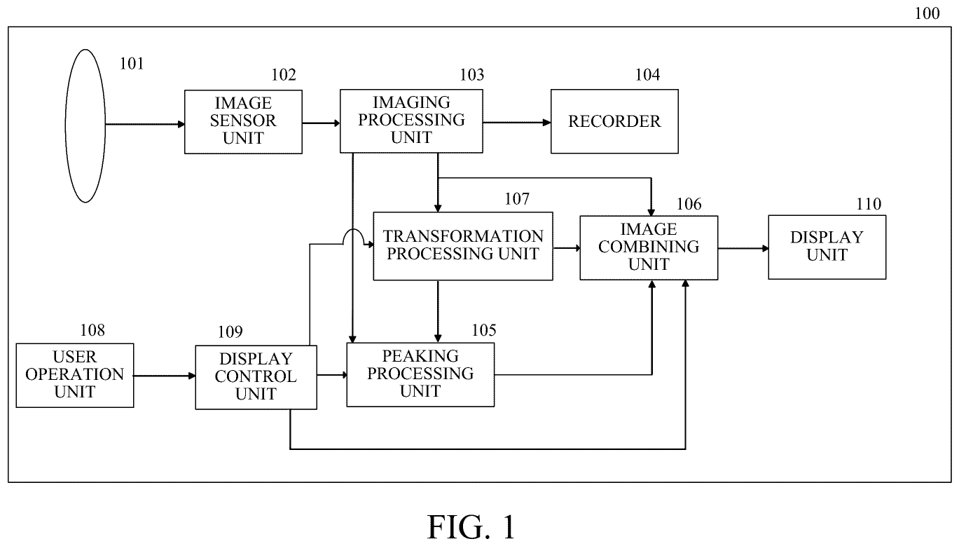

Referring now to FIG. 1, a description will be given of an image pickup apparatus 100 according to a first embodiment. FIG. 1 is a block diagram of the image pickup apparatus 100. The image pickup apparatus 100 includes a lens unit 101, an image sensor unit 102, an imaging processing unit 103, a recorder 104, a peaking processing unit 105, an image combining unit 106, a transformation processing unit 107, a user operation unit 108, a display control unit 109, and a display unit 110. The lens unit 101 has an optical system (imaging optical system) configured to form an object image (optical image) on an imaging surface of the image sensor unit 102, and has a zoom function, a focusing function, and an aperture adjusting function. The image sensor unit 102 includes an image sensor that includes a large number of photoelectric conversion elements, receives the object image formed by the lens unit 101, and converts it into an image signal in pixel units. The image sensor includes, for example, a Complementary Metal Oxide Semiconductor (CMOS) image sensor or a Charged Coupled Device (CCD) image sensor. The imaging processing unit 103 performs image processing for recording and displaying the image signal (captured image data) output from the image sensor unit 102 after correcting scratches and the like caused by the image sensor unit 102. The recorder 104 records the captured image data output from the imaging processing unit 103 in a recording medium (not illustrated) such as an SD card. In this embodiment, the lens unit 101 and the image sensor unit 102 constitute an imaging unit. The imaging unit may further include the imaging processing unit 103.

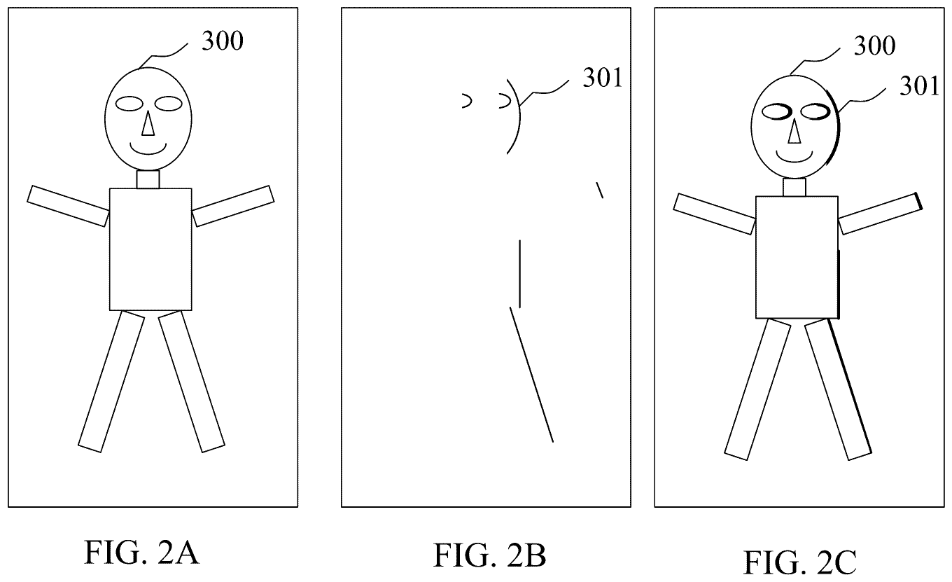

The peaking processing unit 105 has a finite impulse response (FIR) filter. The peaking processing unit 105 can adjust the intensity and frequency of the peaking signal using a gain control signal and a frequency adjustment (or regulation) signal (not illustrated). A detailed description will now be given of a focus assisting function using the peaking processing with reference to FIGS. 2A to 2C. FIGS. 2A to 2C explain the peaking processing. The description here will be given using an image captured by a normal lens, not an image captured by a fisheye lens (fisheye image).

The peaking processor (edge extractor) 105 receives a luminance signal or an RGB development signal as illustrated in FIG. 2A. FIG. 2A illustrates an image before the focus assisting function is executed. The user activates the focus assisting function by operating the user operation unit 108. Thereby, edge information ((focus) peaking image) 301 of an original image 300 is extracted, highlighted, and output from the peaking processing unit 105 as illustrated in FIG. 2B. As illustrated in FIG. 2C, the display unit 110 displays an image (combined image) in which edge information 301 is superimposed on the original image 300. The area in which the edge information 301 is displayed indicates that the image is in focus, and the user can visually recognize an in-focus state.

The image combining unit 106 has a function of superimposing and outputting two images. In this embodiment, the output (peaking image) of the peaking processing unit 105 is superimposed on the output (captured image) of the imaging processing unit 103 or the output (transformed image) of the transformation processing unit 107, and a combined image as illustrated in FIG. 2C is output.

In a case where the user selects to display a perspective projection transformation image (perspective projection image) using the user operation unit 108, the transformation processing unit (perspective projection transformation processing unit) 107 performs perspective projection transformation processing for the captured image data processed by the imaging processing unit 103. The perspective projection transformation is performed by setting a viewing angle, so the perspective projection image is generated by transforming at least one partial area of the captured image.

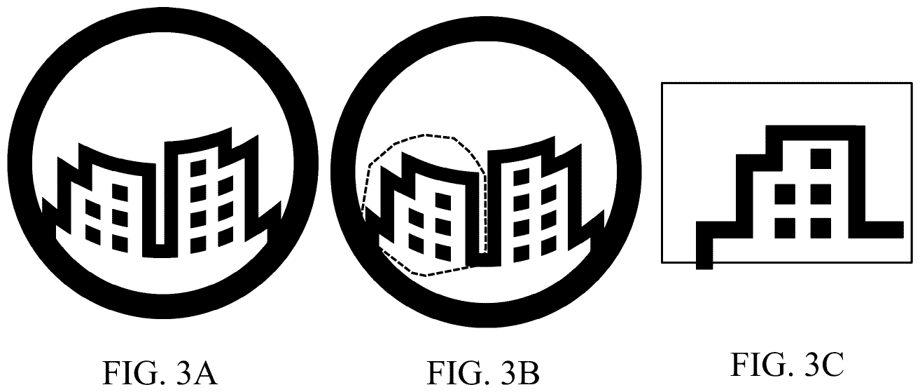

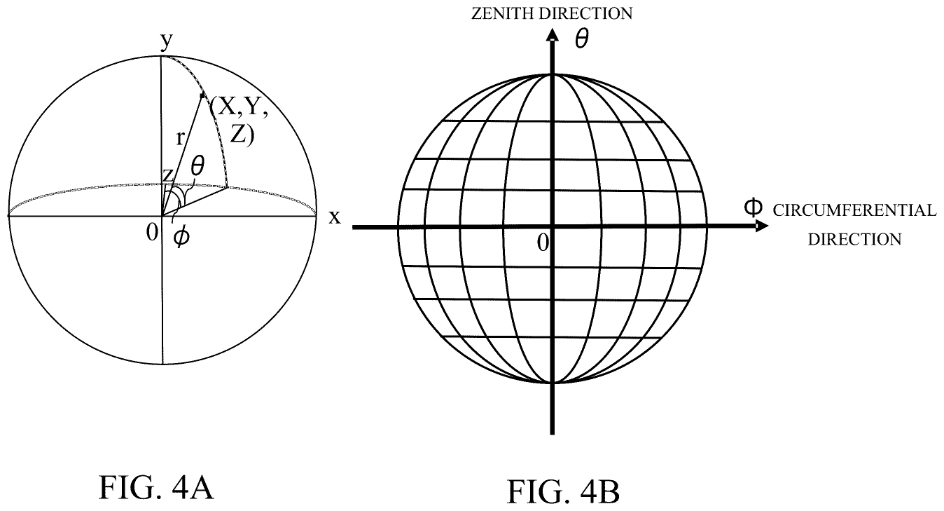

Referring now to FIGS. 3A to 4B, a detailed description will be given of a method of generating a perspective projection image in this embodiment, taking the case of capturing a hemispherical image as an example. FIGS. 3A to 3C explain a captured image and a perspective projection image during VR imaging. FIGS. 4A and 4B explain the correspondence between a captured image (circumferential fisheye image) and a hemisphere in a three-dimensional virtual space.

FIG. 3A illustrates an image captured in a case where a fisheye lens is used in the image pickup apparatus 100. As illustrated in FIG. 3A, the captured image data output from the imaging processing unit 103 is an image that has been circularly cut and distorted (circumferential fisheye image). The transformation processing unit 107 first uses a three-dimensional computer graphics library such as Open Graphics Library for Embedded Systems (Open GL ES) to draw a hemisphere as illustrated in FIG. 4A. Then, the circumferential fisheye image is pasted inside it.

More specifically, as illustrated in FIG. 4B, the circumferential fisheye image is associated with a coordinate system consisting of a vertical angle θ with a zenith direction of the captured image as an axis, and a horizontal angle θ around the axis of the zenith direction. In this case, in a case where the range of the viewing angle of the circumferential fisheye image is 180°, the vertical angle θ and the horizontal angle θ are in the range of −90° to 90°. The coordinate values (θ, φ) of the circumferential fisheye image can be associated with each point on the spherical surface representing the hemispherical image, as illustrated in FIG. 4A. As illustrated in FIG. 4A, the center of the hemisphere is set to 0 and the three-dimensional coordinates on the spherical surface are set to (X, Y, Z). Then, the relationship between the coordinates and the two-dimensional coordinates of the circumferential fisheye image can be expressed by the following equations (1) to (3), where r is the radius of the hemisphere. By pasting the circumferential fisheye image to the inside of the hemisphere based on the coordinate correspondence illustrated by these equations, a hemispherical image can be generated in a three-dimensional virtual space.

$$X = r cos ( θ ) sin ( φ ) \qquad ( 1 )$$

$$Y = r sin ( θ ) \qquad ( 2 )$$

$$Z = r cos ( θ ) cos ( φ ) \qquad ( 3 )$$

In generating a 360°-degree omnidirectional image, circumferential fisheye images of 180° degrees in front and back of the user are acquired and these hemispherical images are connected by the above means.

As described above, an omnidirectional image and a hemispherical image are images pasted to cover the sphere, and therefore are different from an image viewed by the user through the HMD as they are. For example, by performing perspective projection transformation on a partial area of the image, such as an area surrounded by a dotted line in FIG. 3B, an image equivalent to the image viewed by the user through the HMD can be displayed, as illustrated in FIG. 3C.

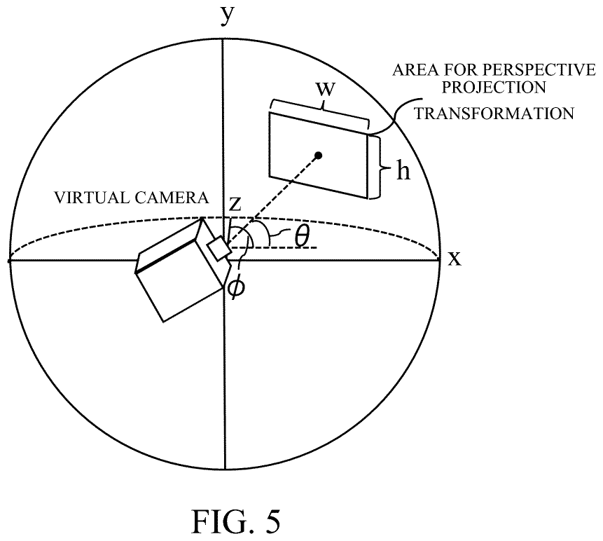

FIG. 5 explains a positional relationship between the virtual camera in the three-dimensional virtual space in the hemispherical image and the area where perspective projection transformation is performed. The virtual camera corresponds to the position of the user's viewpoint viewing the hemispherical image displayed as a three-dimensional solid hemisphere. The area where the perspective projection transformation is performed is determined by the direction (θ, φ) and angle of view of the virtual camera, and the image of this area is displayed on the display unit 110. In FIG. 5, w indicates a horizontal resolution of the display unit 110, and h indicates the vertical resolution of the display unit 110.

The user operation unit 108 is an operation member such as a cross key or a touch panel, and is a user interface that allows the user to select and input various parameters of the image pickup apparatus 100 and the display method of the captured image. The parameters of the image pickup apparatus 100 include, for example, an ISO speed set value or a shutter speed set value, but are not limited to them.

In this embodiment, the display method can be selected from the captured image itself, or an image (transformed image) obtained by applying the perspective projection transformation processing to the captured image. In this embodiment, when the user turns on the focus assisting function, peaking processing is performed for the captured image, the transformed image, etc., and a combined image on which the detected edge information (peaking image) is superimposed can be displayed. In this embodiment, in a case where the user selects the perspective projection transformation display, at least the end portion of the circumferential fisheye image (the peripheral part of the fisheye image) receives the perspective projection transformation on the initial screen, and the user can select an area of the circumferential fisheye image to be displayed by the perspective projection using the user operation unit 108.

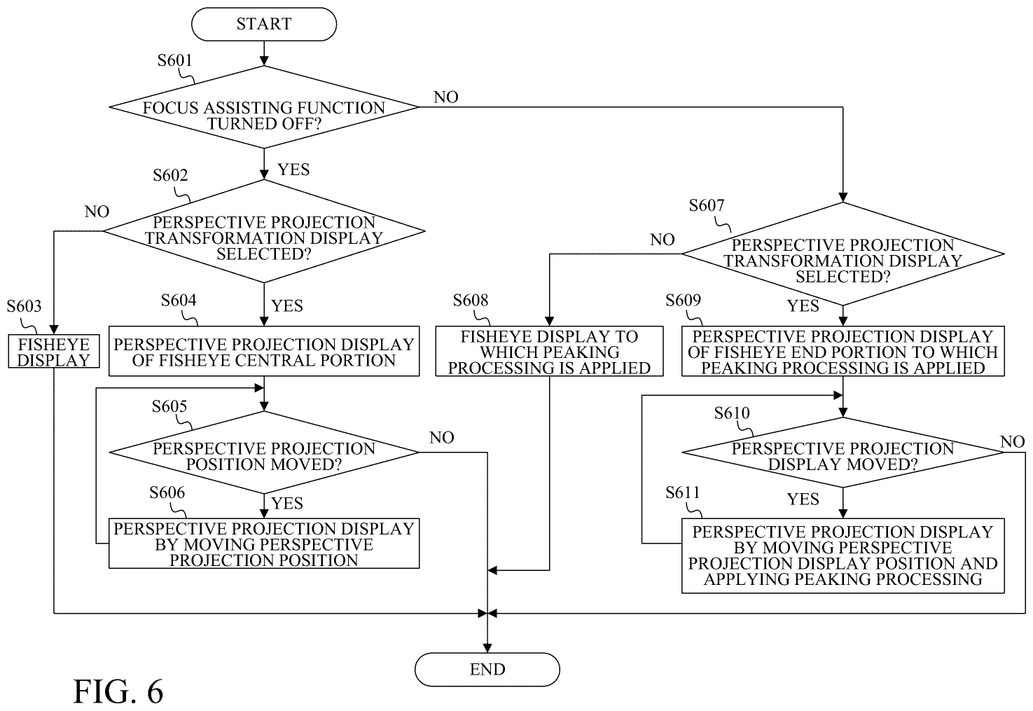

The display control unit 109 controls the transformation processing unit 107, the peaking processing unit 105, and the image combining unit 106 so that the image (at least one of the captured image, the transformed image, and the combined image) set by the user operation unit 108 is displayed on the display unit 110. Referring now to FIG. 6, a description will be given of an image display procedure by the display control unit 109. FIG. 6 is a flowchart illustrating the display processing of the image pickup apparatus 100.

First, in step S601, the user selects turning-on and turning-off of the focus assisting function using the user operation unit 108. At this time, the display control unit 109 determines whether the focus assisting function is turned off or not. In a case where it is determined that the focus assisting function is turned off, the flow proceeds to step S602. In step S602, the display control unit 109 determines whether or not the perspective projection transformation display has been selected by the user. In a case where it is determined that the perspective projection transformation display has not been selected, the flow proceeds to step S603. In step S603, the display control unit 109 controls the transformation processing unit 107, the peaking processing unit 105, and the image combining unit 106 so as not to perform their processing and so that the captured circumferential fisheye image (captured image) is displayed as is (fisheye display).

On the other hand, in a case where it is determined in step S602 that the perspective projection transformation display has been selected by the user, the flow proceeds to step S604. In step S604, the display control unit 109 controls the transformation processing unit 107 so as to perform its processing, but controls the peaking processing unit 105 and the image combining unit 106 so as not to perform their processing. In the initial display, an image obtained by performing the perspective projection transformation for the central portion of the circumferential fisheye image is displayed (perspective projection display of the central portion of the fisheye image). Next, in step S605, it is determined whether or not the user has moved the perspective projection position using the user operation unit 108. In a case where it is determined that the perspective projection position has moved, the flow proceeds to step S606. In step S606, the display control unit 109 controls the transformation processing unit 107 so that perspective projection transformation processing is performed according to the moved position of the perspective projection position and a perspective projection transformed image is displayed. After the processing of step S606, the flow returns to step S605.

On the other hand, in a case where it is determined in step S601 that the focus assisting function is turned on, the flow proceeds to step S607. In step S607, the display control unit 109 determines whether or not the perspective projection transformation display has been selected by the user. In a case where it is determined that the perspective projection transformation display has not been selected, the flow proceeds to step S608. In step S608, the display control unit 109 controls the transformation processing unit 107 so as not to perform its processing, and controls the peaking processing unit 105 and the image combining unit 106 so as to perform their processing. At this time, in step S608, peaking processing is applied to the captured circumferential fisheye image (captured image), and a combined image on which the detected edge information (peaking image) is superimposed is displayed (fisheye display with the peaking processing applied).

On the other hand, in a case where it is determined in step S607 that the perspective projection transformation display has been selected by the user, the flow proceeds to step S609. In step S609, the display control unit 109 controls the transformation processing unit 107, the peaking processing unit 105, and the image combining unit 106 so as to perform their processing. At this time, in step S609, peaking processing is applied to an image (transformed image) obtained by perspective projection transformation of the end portion (peripheral part of the image) of the circumferential fisheye image in the initial display, and a combined image on which the detected edge information (peaking image) is superimposed is displayed. An image obtained by performing the perspective projection transformation for the end portion of the circumferential fisheye image is displayed in the initial display because the captured object is significantly distorted in a compressed form at the end portion of the circumferential fisheye image, and is therefore easily extracted as a high-frequency component, and it becomes difficult for the user to determine whether the image is actually in focus.

Next, in step S610, the display control unit 109 determines whether or not the user has moved the perspective projection position using the user operation unit 108. In a case where it is determined that the perspective projection position has moved, the flow proceeds to step S611. In step S611, the display control unit 109 controls the transformation processing unit 107 so that the perspective projection transformation processing is performed according to the moved position of the perspective projection position, and a perspective projection transformed image is displayed. After the process of step S611, the flow returns to step S610. The focus assisting function may be turned on after the perspective projection transformation display is selected. In a case where the focus assisting function is turned on after the perspective projection transformation display is selected, the peaking processing is applied as it is at the position where the perspective projection transformation display is performed, and a combined image in which the detected edge information is superimposed is displayed.

The display unit 110 is an EVF, a liquid crystal monitor, etc., and has a display panel (an organic EL panel or a liquid crystal panel). The display unit 110 displays an image generated under the control of the display control unit 109 as a live-view image. The display unit 110 also functions as a notification unit configured to notify the user of a partial area that is a target of the perspective projection transformation processing.

This embodiment enables the user to easily perform focusing even in a peripheral part (end portion) of a circumferential fisheye image by applying the peaking processing to the perspective projection image and displaying a combined image on which the detected edge information is superimposed. Thus, the user can first focus on the central area with less distortion using the circumferential fisheye image, and then perform focusing for the peripheral part (end portion) using the perspective projection image.

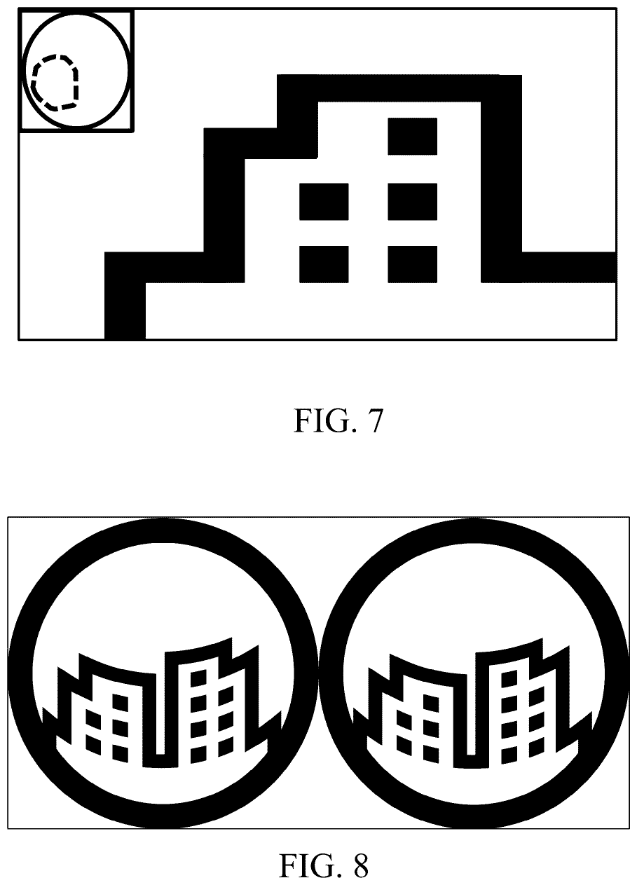

In performing the perspective projection transformation display, the area of the circumferential fisheye image that has been perspective projection transformed and displayed may be displayed in an on-screen display (OSD) form, as illustrated in FIG. 7. FIG. 7 illustrates the display contents of the image pickup apparatus 100, and illustrates an OSD example. Due to the OSD, the user can easily recognize a confirmed in-focus area of the original circumferential fisheye image in a case where the user moves the perspective projection position. The area displayed as the initial image of the perspective projection image may be fixed to the left end portion, etc., or may be switched according to the content of the captured image. For example, it is conceivable to calculate the variance of pixel values of the captured image and display a portion where the variance is large and distortion is likely to be large (e.g., a portion where the variance is greater than a predetermined threshold value).

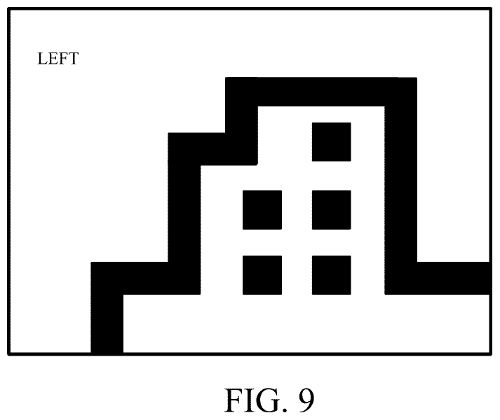

In performing stereoscopically viewable VR imaging using the parallax of both eyes, such as the VR180, a circumferential fisheye image for the right eye and a circumferential fisheye image for the left eye are recorded as illustrated in FIG. 8. FIG. 8 explains captured images of the VR180. In performing the perspective projection transformation display on the image illustrated in FIG. 8, the OSD may be performed to indicate whether the circumferential fisheye image for the right eye or the circumferential fisheye image for the left eye has been subjected to the perspective projection transformation, as illustrated in FIG. 9. FIG. 9 illustrates the display content of the VR180 in the image pickup apparatus 100, and is a display example illustrating that the circumferential fisheye image for the left eye has been subjected to the perspective projection transformation. The user operation unit 108 may be able to switch between displaying the circumferential fisheye image for the right eye and the circumferential fisheye image for the left eye.

In this embodiment, the partial area of the captured image (fisheye image) that is a target of the perspective projection transformation processing is, but not limited to, the end portion of the captured image. For example, the area for the perspective projection transformation processing may be any peripheral part of the captured image.

### Second Embodiment

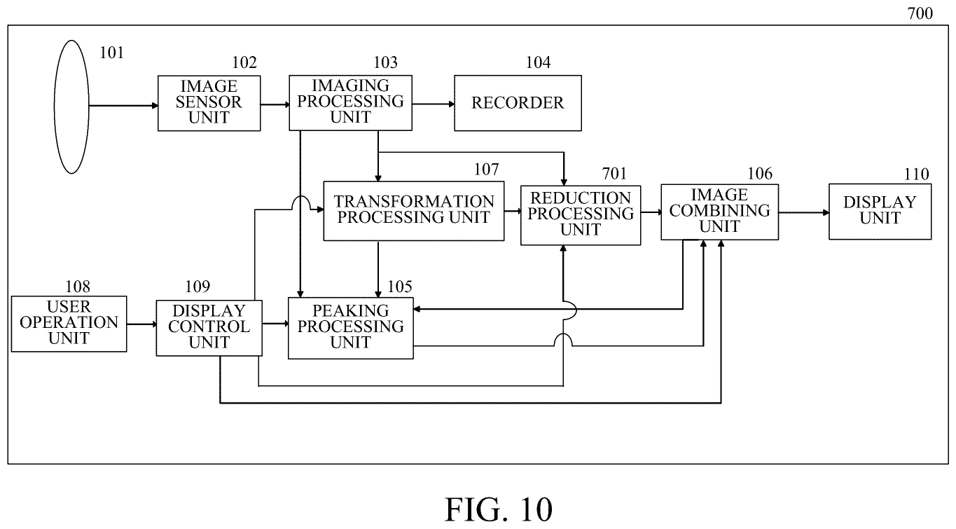

Referring now to FIGS. 10 to 13, a description will be given of an image pickup apparatus 700 according to a second embodiment. FIG. 10 is a block diagram of the image pickup apparatus 700 according to this embodiment. The image pickup apparatus 700 is different from the image pickup apparatus 100 according to the first embodiment in that it includes a reduction processing unit 701, in the processing of the image combining unit 106 and the display control unit 109 in a case where the focus assisting function is turned on, and in the display content on the display unit 110. The other configurations and operations of the image pickup apparatus 700 are similar to those of the image pickup apparatus 100, and thus a description thereof will be omitted.

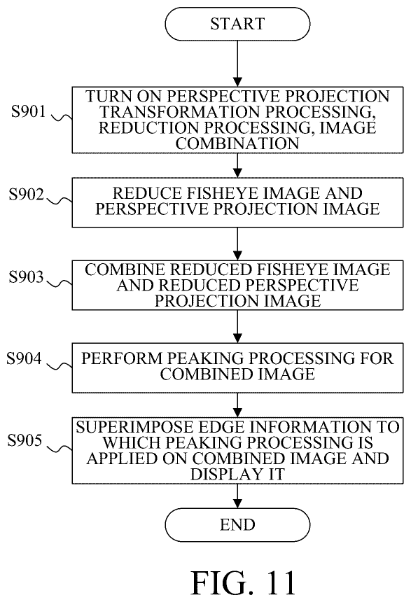

Referring now to FIG. 11, a description will be given of the procedure for displaying an image by the display control unit 109 in a case where the focus assisting function is turned on will be described. FIG. 11 is a flowchart illustrating the display processing of the image pickup apparatus 700.

First, in step S901, in a case where the user turns on the focus assisting function using the user operation unit 108, the display control unit 109 controls the transformation processing unit 107, the reduction processing unit 701, and the image combining unit 106 so as to perform (turn on) their processing. Next, in step S902, the reduction processing unit 701 reduces a fisheye image input from the imaging processing unit 103 and a transformed image input from the transformation processing unit 107 so that these images can be simultaneously displayed on the display unit 110. The reduction processing unit 701 then outputs a reduced fisheye image obtained by reducing the fisheye image, and a reduced transformed image obtained by reducing the transformed image.

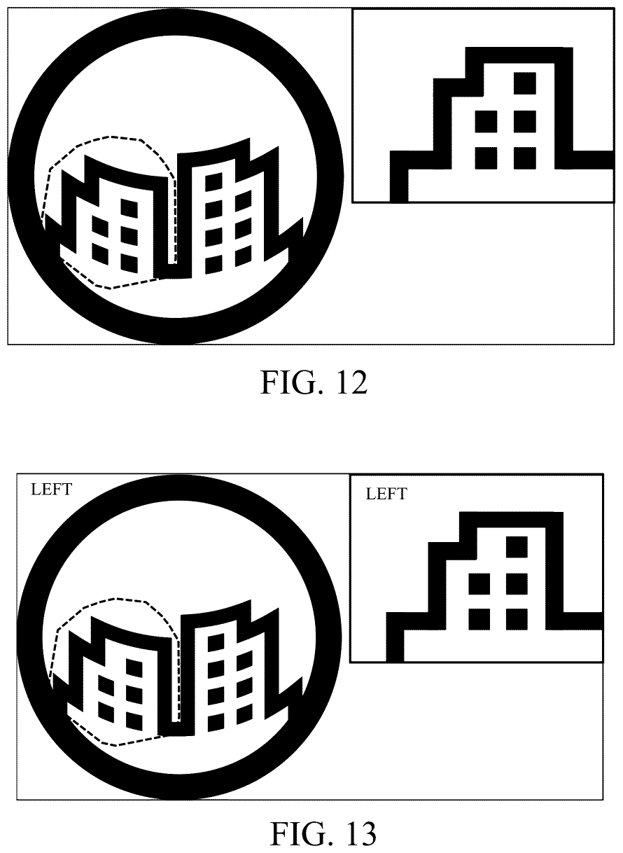

Next, in step S903, the image combining unit 106 combines the reduced fisheye image and reduced perspective projection image input from the reduction processing unit 701 to generate an image illustrated in FIG. 12. Next, in step S904, the peaking processing unit 105 performs peaking processing for the combined image input from the image combining unit 106, and outputs the result to the image combining unit 106. Next, in step S905, the image combining unit 106 combines the image combined in step S903 (the image in FIG. 12) and the output of the peaking processing unit 105 to generate an image in which edge information is superimposed on the image in FIG. 12, and displays it on the display unit 110.

This embodiment first combines the circumferential fisheye image and the perspective projection image, and then generates a combined image on which the edge information detected by the peaking processing is superimposed. Thereby, this embodiment can perform focusing using a peaking image in which the circumferential fisheye image and the perspective projection image are simultaneously displayed. Therefore, the user can first perform focusing for the central part with less distortion using the circumferential fisheye image, without switching between the circumferential fisheye image and the perspective projection image, and then perform focusing for the image end using the perspective projection image. As a result, intended focusing can be easily performed.

In performing VR imaging utilizing the parallax between both eyes like the VR180, as illustrated in FIG. 13, the OSD may be performed to indicate which of the circumferential fisheye images for the right eye and the left eye is displayed and which of the circumferential fisheye images for the right eye and the left eye is a perspective projection transformation image. FIG. 13 illustrates the display content of the VR180 in the image pickup apparatus 700, and illustrates the circumferential fisheye image for the left eye and the circumferential fisheye image for the left eye that has received the perspective projection transformation. The user operation unit 108 may be able to switch between the image for the right eye and the image for the left eye.

### Third Embodiment

Referring now to FIGS. 10, 14 to 16, a description will be given of an image pickup apparatus 700 according to the third embodiment. The image pickup apparatus according to this embodiment is different from the image pickup apparatus 700 according to the second embodiment in the processing performed by the image combining unit 106 and the display control unit 109 and the display content on the display unit 110 in a case where the focus assisting function is turned on. The other configurations and operations of the image pickup apparatus according to this embodiment are similar to those of the image pickup apparatus 700 according to the second embodiment, and thus a description thereof will be omitted.

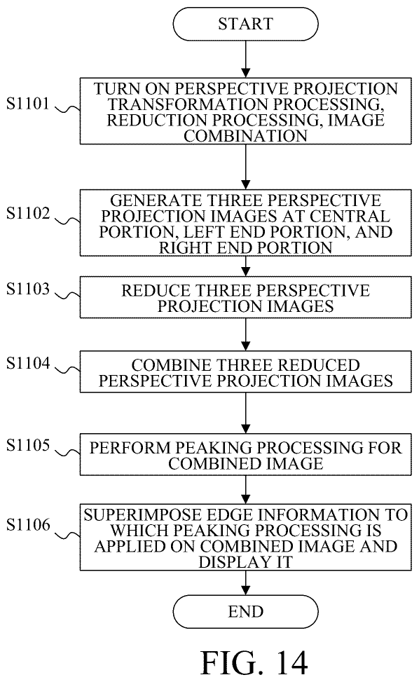

The image display procedure of the display control unit 109 in a case where the focus assisting function is turned on will be described with reference to FIG. 14. FIG. 14 is a flowchart illustrating the display processing of the image pickup apparatus according to this embodiment.

First, in step S1101, in a case where the user turns on the focus assisting function with the user operation unit 108, the display control unit 109 controls the transformation processing unit 107, the reduction processing unit 701, and the image combining unit 106 so as to perform (turn on) their processing. Next, in step S1102, the transformation processing unit 107 performs the perspective projection transformation processing for each of three locations (a plurality of partial areas including a first partial area and a second partial area) at the central portion, left end portion, and right end portion of the circumferential fisheye image input from the imaging processing unit 103. Then, the transformation processing unit 107 outputs three perspective projection images (a plurality of transformed images including a first transformed image and a second transformed image). Next, in step S1103, the reduction processing unit 701 reduces each of the three perspective projection images input from the transformation processing unit 107 so that the three perspective projection images can be simultaneously displayed on the display unit 110.

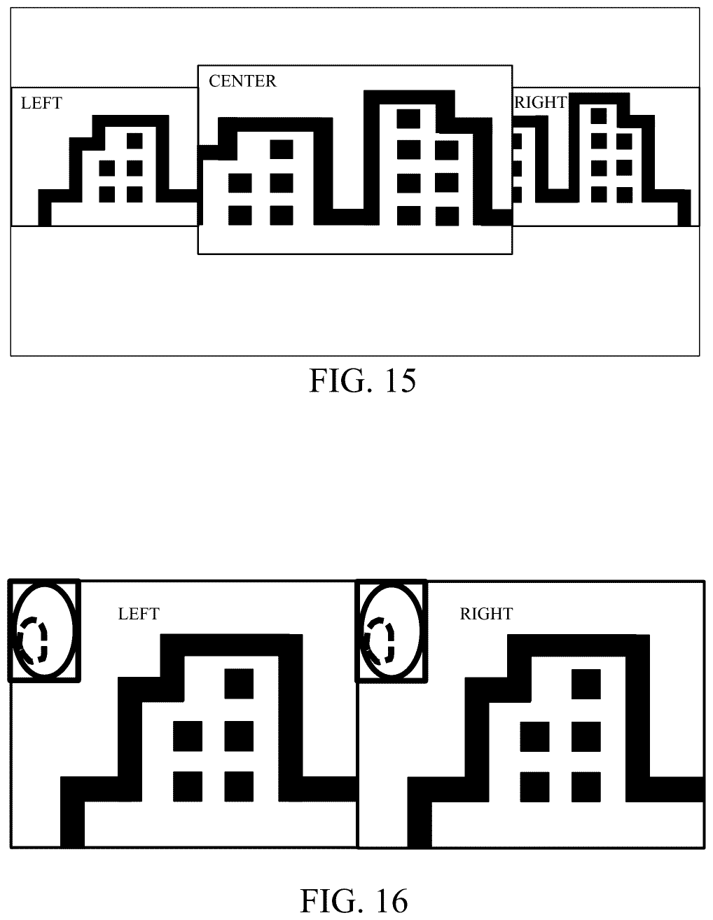

Next, in step S1104, the image combining unit 106 combines the reduced images input from the reduction processing unit 701 to generate an image illustrated in FIG. 15 (three reduced perspective projection images). FIG. 15 illustrates the display content of the image pickup apparatus, illustrating three reduced perspective projection images. Next, in step S1105, the peaking processing unit 105 performs peaking processing for the combined image input from the image combining unit 106, and outputs the result to the image combining unit 106. Next, in step S1106, the image combining unit 106 combines the image combined in step S1104 (the image in FIG. 15) and the output of the peaking processing unit 105 to generate an image in which edge information is superimposed on the image in FIG. 15, and causes the display unit 110 to display that image. Due to this display, the user can perform focusing for the central portion of the image while it is actually displayed on the VR goggles, and perform focusing for the end portion of the image.

This embodiment simultaneously displays the central portion, left end portion, and right end portion of the image, but for example, the images may be combined and displayed after the perspective projection transformation is performed at other viewpoints such as the upper end portion and lower end portion. The user may be able to set which viewpoint is displayed on the display screen of each perspective projection transformation using the user operation unit 108. In performing stereoscopically viewable VR imaging using the parallax of both eyes such as VR180, both perspective projection transformed images for the right eye and the left eye may be displayed simultaneously as illustrated in FIG. 16. FIG. 16 illustrates the display contents of VR180 in the image pickup apparatus according to this embodiment. Due to this display, the user can perform the intended focusing without switching between the image for the right eye and the image for the left eye. As in the case of FIG. 10, a displayed area of the circumferential fisheye image for which the perspective projection transformation has been performed may be displayed in the OSD form.

### Other Embodiments

Embodiment(s) of the disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read-only memory (ROM), a storage of distributed computing systems, an optical disc (such as a compact disc (CD), digital versatile disc (DVD), or Blu-ray Disc (BD)™), a flash memory device, a memory card, and the like.

While the disclosure has described example embodiments, it is to be understood that the disclosure is not limited to the example embodiments. The scope of the following claims is to be accorded the broadest interpretation so as to encompass all such modifications and equivalent structures and functions.

Each embodiment can provide an image pickup apparatus that allows a user to easily perform focusing during VR imaging, a control method for the image pickup apparatus, and a storage medium.

What is claimed is:

1. An image pickup apparatus comprising:
an imaging unit configured to acquire a captured image; and
a processor configured to:
perform predetermined transformation processing for correcting image distortion for at least one partial area of the captured image to generate a transformed image,
perform focus peaking processing for at least one of the captured image and the transformed image to generate a focus-peaking image,
generate a combined image of the at least one of the captured image and the transformed image, and the focus-peaking image, and
control a display unit so as to display the combined image,
wherein in a case where the processor is set to perform the focus peaking processing for the transformed image to display the combined image, the processor causes the display unit to display the combined image of the transformed image and the focus-peaking image, and
wherein the partial area includes a peripheral part of the captured image.

2. The image pickup apparatus according to claim 1, wherein the peripheral part includes an end portion of the captured image.

3. The image pickup apparatus according to claim 1, wherein the processor is configured to cause the display unit to display the combined image of the transformed image and the focus-peaking image in initial display.

4. The image pickup apparatus according to claim 1, wherein the processor is configured to cause the display unit to simultaneously display the captured image and the transformed image.

5. The image pickup apparatus according to claim 4, wherein the processor is configured to cause the display unit to simultaneously display the captured image and the combined image.

6. The image pickup apparatus according to claim 4, wherein the processor is configured to reduce an image, and
wherein each of the captured image and the transformed image is an image reduced by the processor.

7. The image pickup apparatus according to claim 6, wherein the processor is configured to perform the focus peaking processing for the captured image or the transformed image reduced by the processor.

8. The image pickup apparatus according to claim 1, wherein the partial area includes a first partial area and a second partial area,
wherein the processor is configured to:
perform the predetermined transformation processing for the first partial area to generate a first transformed image,
perform the predetermined transformation processing for the second partial area to generate a second transformed image, and
cause the display unit to simultaneously display the first transformed image and the second transformed image.

9. The image pickup apparatus according to claim 1, further comprising a user operation unit,
wherein the processor is configured to change a position of the partial area that is a target of the predetermined transformation processing according to a signal from the user operation unit.

10. The image pickup apparatus according to claim 1, wherein the predetermined transformation processing is perspective projection transformation processing.

11. The image pickup apparatus according to claim 10, wherein the transformed image corresponds to an image viewable as a VR content.

12. The image pickup apparatus according to claim 1, wherein the focus-peaking image is an image that includes edge information in at least one of the captured image and the transformed image.

13. The image pickup apparatus according to claim 1, further comprising a notification unit configured to notify a user of the partial area that is a target of the predetermined transformation processing.

14. The image pickup apparatus according to claim 1, wherein the processor is configured to cause the display unit to display the partial area of the captured image that has a variance value greater than a predetermined variance value in initial display.

15. The image pickup apparatus according to claim 1, wherein the captured image is a fisheye image acquired using a fisheye lens.

16. A method for controlling an image pickup apparatus, the method comprising:
acquiring a captured image;
perform predetermined transformation processing for correcting image distortion for at least one partial area of the captured image to generate a transformed image,
perform focus peaking processing for at least one of the captured image and the transformed image to generate a focus-peaking image,
generate a combined image of the at least one of the captured image and the transformed image, and the focus-peaking image, and
display the combined image,
wherein the partial area includes a peripheral part of the captured image.

17. A computer-readable storage medium storing a program that causes a computer to execute the method according to claim 16.
